(19) United States
(12) Patent Application Publication
(10) Pub. No.: US 2005/0211534 A1
(43) Pub. Date: Sep. 29, 2005

(54) Conveyor and support

(76) Inventor: Matthew John Tefend, Maineville, OH (US)

Correspondence Address: FROST BROWN TODD, LLC, 2200 PNC CENTER, 201 E. FIFTH STREET, CINCINNATI, OH, 45202, US

(21) Appl. No.: 10/992,956

(22) Filed: Mar. 3, 2005

Related U.S. Application Data
(60) Provisional application No. 60/520,931, filed on Nov. 18, 2003.

(51) Int. Cl. B65G 21/00

(52) U.S. Cl. 198/860.2

(57) ABSTRACT

A conveyor has frame sections formed from two laterally spaced apart longitudinal truss frames connected together on their ends by lateral truss frames. Sections include trussed beams which support the conveying medium. In the case of a moving conveying medium, upper and lower trussed beams are used to support the conveying run and the return run. Divert chassis are carried by one or more frame sections, secured in divert chassis tracks which allow easy installation adjustment of the divert locations. Spur conveyor supports are included which allow easy installation and adjustment of the spur conveyor locations.

This application claims priority from U.S. Provisional Patent Application Ser. No. 60/520,931, filed Nov. 18, 2003, titled Conveyor, the disclosure of which is incorporated herein by reference. This application also incorporates by reference the disclosures of U.S. patent application Ser. No. 10/800,070, filed Mar. 12, 2003, titled Sortation Conveyor, U.S. patent application Ser. No. 10/409,749, filed Apr. 8, 2003, titled Sortation System Pusher, U.S. Provisional Patent Application Ser. No. 60/445,974, filed Feb. 7, 2003, titled Slat Sortation Conveyor; and U.S. Provisional Patent Application Ser. No. 60/428,366, filed Nov. 22, 2002, titled Pusher For Sortation System.

### BACKGROUND OF THE INVENTION

This invention relates generally to conveyors for material handling, such as those used in distribution centers to convey articles. The invention will be disclosed in connection with, but not limited to, a sortation conveyor.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective view of an embodiment of several sections of a truss frame for a conveyor constructed according to the present invention, depicted for use to support a sortation conveyor.

FIG. 2 is an exploded perspective view of a section of the truss frame illustrated in FIG. 1.

FIG. 3 is an enlarged, fragmentary perspective view of a support leg and two adjacent sections of the truss frame illustrated in FIG. 1.

FIG. 4 is an enlarged, fragmentary perspective view of the adjustable foot at the end of the support leg and two adjacent sections illustrated in FIG. 3.

FIG. 5 is an end view of a section of a sortation conveyor constructed according to aspects of the current invention.

FIG. 6 is an enlarged, fragmentary view of a portion of the sortation conveyor as shown in FIG. 5, showing a gravity spur conveyor.

FIG. 7 is an enlarged, fragmentary perspective view of an end of a section of the sortation conveyor of FIG. 5.

FIG. 8 is perspective view of several sections of a sortation conveyor constructed according to aspects of the current invention, showing the divert chassis and spur conveyor supports.

FIG. 9 is a top, plan view of a divert chassis.

FIG. 10 is an enlarged, fragmentary, perspective view of a portion of the frame for the sortation conveyor shown in FIG. 8, illustrating the mounting of the spur conveyor supports.

FIG. 11 is a perspective view of a powered spur conveyor, with part of its conveying medium omitted, mounted to a support, with the sortation conveyor omitted for illustration purposes.

FIG. 12 is a fragmentary perspective view of the sortation conveyor of FIG. 8, showing the spur conveyor of FIG. 11 attached to the sortation conveyor through the support.

FIG. 13 is a top, plan view of the sortation conveyor of FIG. 8, showing two adjacent spur conveyors and associated divert chassis.

FIG. 14 is a fragmentary perspective view of composite tubes, end cap and pusher shoe for the sortation conveyor.

FIG. 15 is a fragmentary perspective view of composite slats, end cap and pusher shoe for the sortation conveyor.

FIG. 16 is a perspective view of a powertrain chassis.

FIG. 17 is a side view of the powertrain chassis of FIG. 16.

Reference will now be made in detail to an embodiment of the invention, an example of which is illustrated in the accompanying drawings.

### DETAILED DESCRIPTION OF AN EMBODIMENT OF THE INVENTION

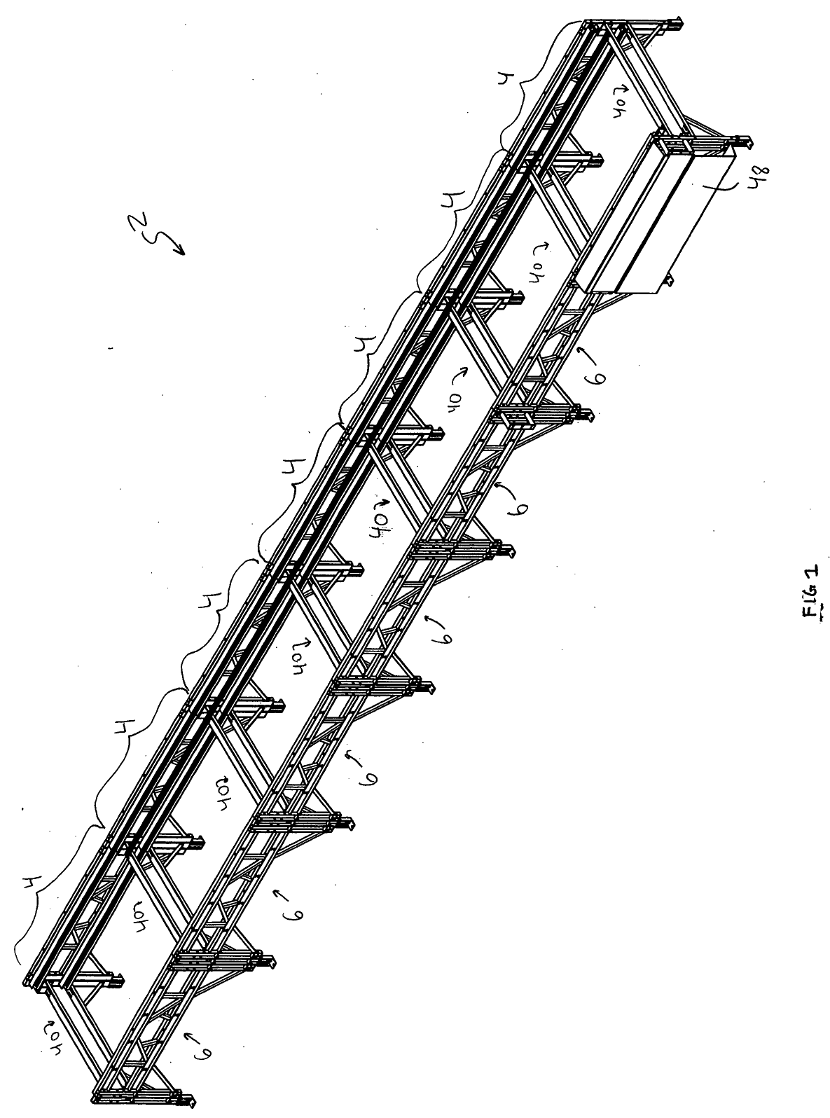

Referring now to the drawings in detail, which depict an exemplary embodiment of the present invention, wherein like numerals indicate the same elements throughout the views, FIG. 1 illustrates conveyor frame 2 for supporting a material handling conveyor. Conveyor frame 2 is configured to support a conveying medium, which is not illustrated in FIG. 1. The conveying medium may be formed of any appropriate configuration or construction, such as, by way of non-limiting examples, a fixed conveying medium having conveying members which do not move longitudinally but which rotate about an axis, which may extend laterally (between the sides of conveyor frame 2) including for example skate wheels and rollers, and such as a moving conveying medium which moves longitudinally as an endless component, including for example a belt, or tubes or slats as may be found in a sortation conveyor. Whether fixed or moving, the conveying medium may be supported primarily by the sides of conveyor frame 2. A conveyor frame constructed according to the teachings of the present invention may be utilized to support any type of conveying medium regardless of the specific conveying medium configuration or construction. For illustrative purposes, frame 2 is depicted as a sortation conveyor supporting an endless series of lateral members carrying pusher shoes, it being recognized that practice of the present invention is not limited to a sortation conveyor.

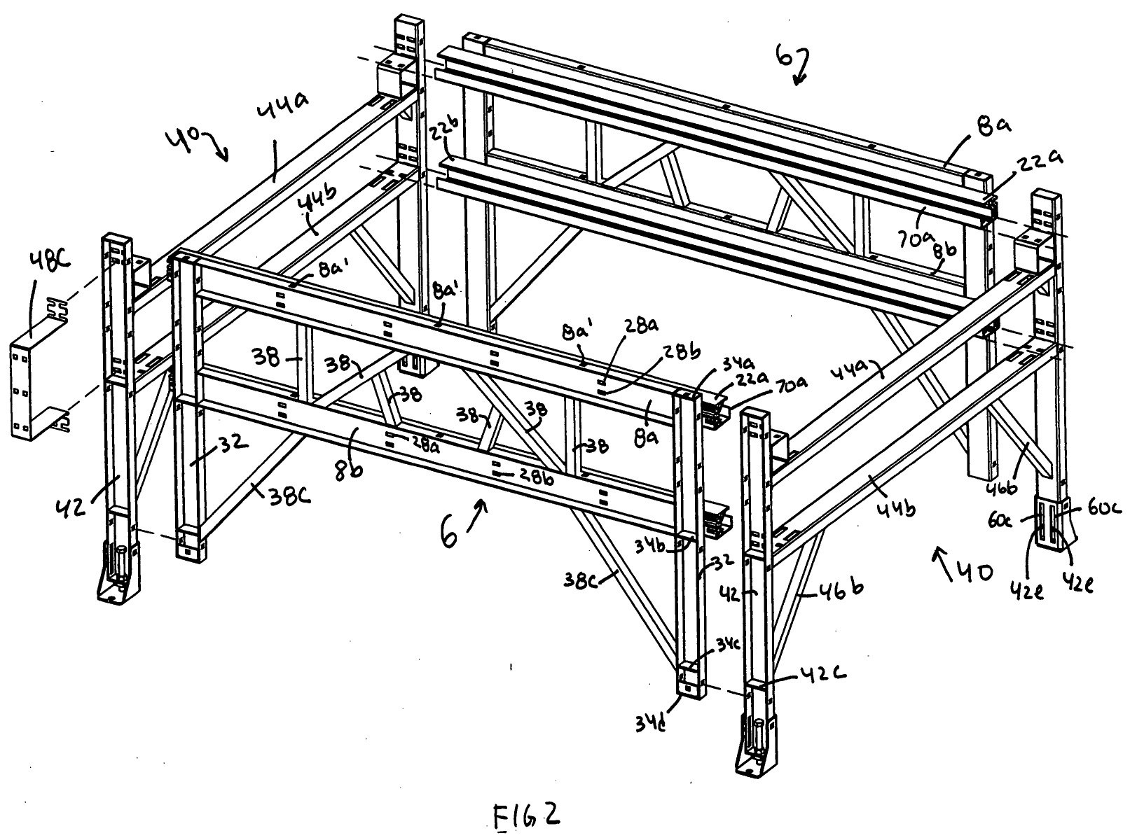

Frame 2 includes individual frame sections 4, also referred to as modules, one of which is shown in FIG. 2 as an exploded perspective view. Frame sections 4 may be, but are not required to be, constructed having a uniform length, and configured to be connected together during installation by any suitable method or structure, such as by fasteners, for example carriage bolts, hex bolts, hooks or rivets, or gluing or welding. Unless otherwise indicated, any component indicated as being connected to another component may be connected by any suitable method or structure, such as by fasteners, for example carriage bolts, hex bolts, bolts, hooks or rivets, or gluing or welding.

Uniform length sections, coupled with various aspects of the invention described below, allow multiple identical sections to be connected together to configure the conveyor to the desired total length, substantially eliminating the need to custom design the conveyor for each installation, commonizing fabrication and installation steps, and reducing the number of parts required to be stocked. To accommodate a total conveyor length which is not an even multiple of the primary length of a module, one or more sections having the same basic construction but a different length may be used. Depending on the design requirements, shorter sections may not have the same basic construction, not requiring a frame constructed in accordance with all of the teachings of the present invention. For example, the length of each frame section 4 (to the center of each support leg) may be five feet. To accommodate a conveyor length which is not a multiple of five feet, a shorter section may be constructed. To maximize commonality between the parts and between different conveyors, standard shorter sections may be used, such as one, two or three feet. This system would allow the construction of a conveyor having a length which is a multiple of feet. Depending on the specific parameters, such short sections may not require trussed beams.

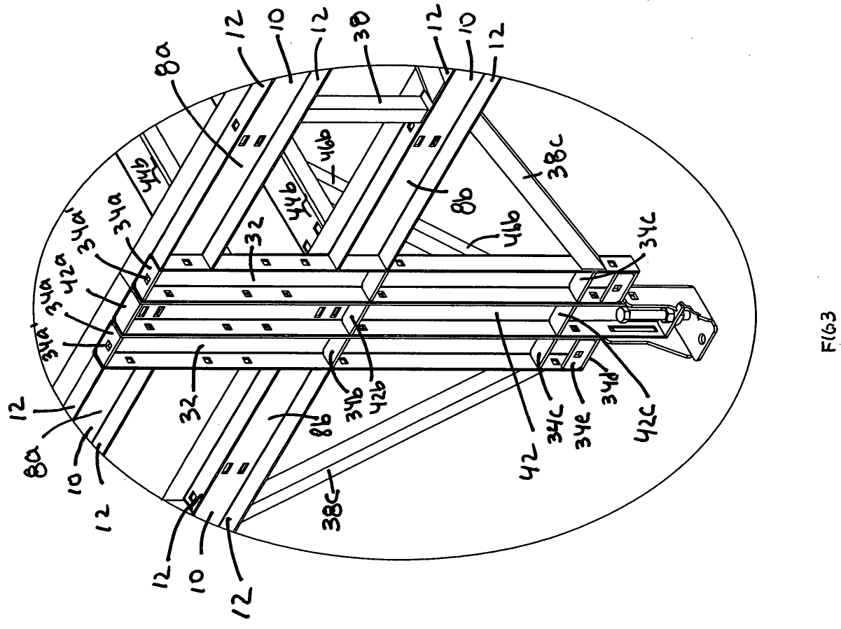

Referring also to FIG. 2, frame section 4 includes two laterally spaced apart longitudinal truss frames 6, which may also be referred to as longitudinal truss sections, which extend longitudinally parallel to the direction of travel for the conveying medium. Both longitudinal truss frames 6 are depicted as being substantially the same, so only one will be discussed. Longitudinal truss frame 6 is depicted having two vertically spaced apart longitudinal beams 8a and 8b extending substantially the length of longitudinal truss frame 6. As used herein, a beam is a body with one dimension large compared with the other dimension, whose function is to carry loads which are perpendicular to the large dimension and to carry bending moments. Each beam 8a and 8b is depicted as a channel opening outwardly (relative to the location of the conveying medium), lateral relative to the longitudinal direction. Referring also to FIG. 3, each beam 8a and 8b includes vertically oriented web portion 10 connecting two spaced apart laterally outwardly extending lateral flanges 12.

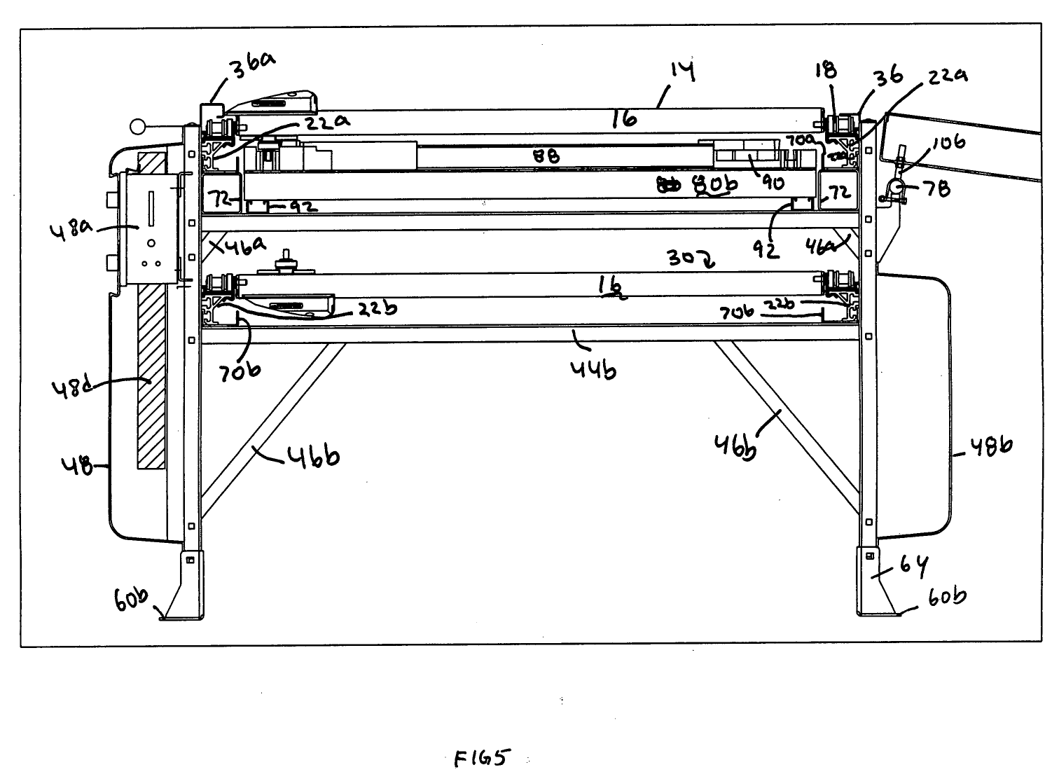

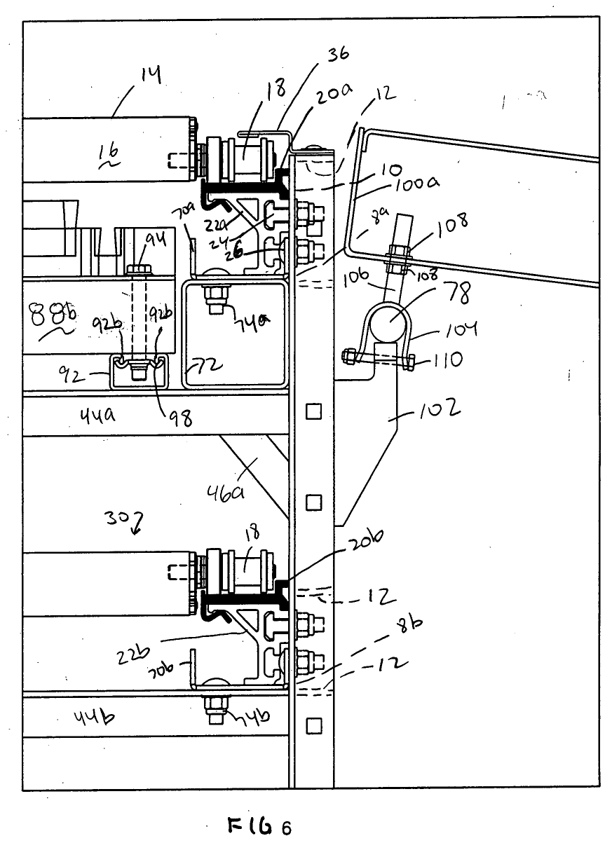

Upper beam 8a is configured to support a length of the upper conveying medium, also referred to as the conveying run (not shown in FIG. 2) since articles are conveyed on this run, along the length of upper beam 8a, with a plurality of upper beams 8a supporting substantially the entire length of the upper conveying medium (except, for example adjacent the end idlers and drive). With reference also to FIGS. 5 & 6, upper conveying medium 14 of a sortation conveyor comprises moving conveyor elements 16 which may be driven at each end by chains 18 or other suitable driven elements. Chain 18 may be directly supported by guide 20a which may be supported by support 22a. Guide 20a and support 22a may be of any suitable configuration and material, such as UHMW polyethylene for guide 20a and aluminum for support 22a, but is not limited thereto. Support 22a may be connected to web 10 of upper beam 8a, through fasteners 24 (see FIG. 6) which have head portions disposed in a longitudinal slot formed in support 22a, and which extend through respective openings 28a formed in web 10. The return run of the conveying medium may also be supported in a similar fashion through guide 20b and support 22b.

Beam 8a has a C-shaped cross section to resist bending that results from supporting the upper conveying medium. The locations of flanges 12 are based on the location of the displacement resulting from supporting the upper conveying medium as well as allowing adequate room for other components, such as chain 18, chain cover 26, guide 20a and fasteners 24 and 26.

Longitudinal truss frame 6 includes lower beam 8b which supports return run 30 of the conveying medium in the same manner as described above with respect to upper beam 8a. As mentioned above, the practice of the present invention is not limited to conveyors which have a return run, or to a sortation conveyor. In such a case, there is only upper conveying medium 14, plus articles carried thereon, that must be supported. In the embodiment depicted, beams 8a and 8b are made of 10 gage steel and measure 3⅜ inches from outer flange to outer flange, with radiused corners. It is noted that in the embodiment depicted, carriage bolts may be used for many connections between components. The thickness of 10 gage steel provides adequate thickness for the shoulder of the carriage bolt and to resist the square hole/opening from being deformed. Although lower beam 8b is identical to upper beam 8a for commonality of components so as to reduce the number of unique components, each beam 8a and 8b may have its own unique size and shape dictated by design considerations.

Referring also to FIG. 3, each end of upper beam 8a and lower beam 8b is connected to a respective vertical member 32. In the embodiment depicted, members 32 are shown as open channels having cross sections similar to the cross sectional shapes of beams 8a and 8b. In the embodiment depicted, members 32 are made of steel and measure 2½ inches from outer flange to outer flange, with radiused corners. In the embodiment depicted, the ends of beams 8a and 8b, which may be open as illustrated, are connected to the flanges of members 32 as shown. Bulkhead 34a may be included to enclose the otherwise open upper end of members 32, being generally aligned with upper flange 12 of upper beam 8a. Upper flange 12 of upper beam 8a includes openings 8a′, and bulkheads 34a include openings 34a′, which are used in bolting chain covers 36 and 36a to longitudinal truss frame 6 (see FIGS. 5 & 6). Lower beam 8b includes matching openings, which are not used, since lower beam 8b is identical to upper beam 8a. It is noted that lower beam 8b does not have to be identical to upper beam 8a, since the loading on support 22b is different than that of 22a since the return run does not carry articles, and since there is not a chain cover.

As shown, bulkheads 34b may be connected to member 32, and is depicted generally aligned with lower flange 12 of lower beam 8b. The location of bulkheads 34a and 34b depicted create substantially continuous respective flanges extending the length of the conveyor when fully assembled, although offset bulkhead locations may provide a similar function. Additional bulkheads 34c and 34d may also be connected to member 32 at various locations to resist bending of the flanges. Bulkheads 34c are located proximal to where the lower end of truss member 38c is connected to a flange of member 32, resisting bending of the flange. Bulkheads 34d may be connected to the lower end of member 32, closing the channel. Bulkheads 34e include openings 34e′ and may be disposed parallel to the web. Bulkheads 34e serve as mounting brackets with openings 34e′ receiving respective fasteners which may secure the lower edges of side covers 48 (see FIG. 1).

Returning to FIG. 2, longitudinal truss frame 6 is depicted as a skeletal structure, having a plurality of truss members 38 extending between upper and lower beams 8a and 8b and members 32, as well as extending from truss members themselves. With the presence of truss members 38, beams 8a and 8b are trussed beams, meaning that they are supported by truss members to stiffen and reduce deflection. There are many different types of trusses which are suitable to form longitudinal truss frame 6 for use as frame sections 4 of conveyor frame 2. The truss body configuration depicted in the Figures have aspects similar to arch trusses and to rigid frame truss, but are not limited thereto. The locations of truss members 38 in the embodiment depicted were determined based on a finite element analysis of the conveyor. The orientation and number of truss members 38 depends on the conveyor.

Longitudinal truss frame 6, as well as truss members 38, have sufficient rigidity to prevent undesired bending out of plane. In the embodiment depicted, truss members 38 are square, one inch by one inch hollow tubes made from 11 gauge steel, although any suitable cross sectional configuration may be used including for example circular, polygonal, and solid. In the embodiment depicted, the ends of truss members 38 are connected through any suitable connection capable of transferring moments and loads. If moments are not required to be transferred by a truss member 38, other suitable connections may be used, such as pins or bolts.

As can be seen in FIGS. 2 & 3, frame section 4 includes two spaced apart lateral truss frames 40, which are connected to the ends of longitudinal truss frames 6. Each lateral truss frame 40 is depicted as a skeletal structure, configured as a rigid truss having two laterally spaced apart support legs 42 connected to each other through upper and lower cross beams 44a and 44b, and a plurality of truss members 46a extending between upper cross beam 44a and legs 42, and a plurality of truss members 46b extending between lower cross beam 44b and support legs 42. Support legs are supported by any thing external to conveyor frame 2 which is sufficiently suitable to provide the necessary support. The design considerations for the truss body configuration discussed above in respect to the longitudinal truss frame 6 are applicable to the lateral truss frame 40, and there are many different types of trusses which are suitable to form lateral truss frame 40 for use in frame sections 4 of conveyor frame 2. The number, size and location of truss members 46a and 46b in the embodiment depicted were determined based on a finite element analysis of the conveyor, and lateral truss frame 40 has sufficient rigidity to prevent undesired bending out of plane. In the embodiment depicted, truss members 46a and 46b are square, one inch by one inch hollow tubes made from 11 gauge steel, although any suitable cross sectional configuration may be used including for example circular, polygonal, and solid. As depicted, the ends of truss members 46a and 46b are connected to the webs of cross beams 44a and 44b and support legs 42 through any suitable connection capable of transferring moments and loads. If moments are not required to be transferred by a truss member 46, other suitable connections may be used, such as pins or bolts.

Each support leg 42 may include bulkhead 42a connected to the upper end enclosing the top end of the channel, completing an essentially continuous top mounting surface, such as, as shown in the embodiment depicted, for chain covers 36 and 36a. Each support leg 42 also includes bulkhead 42b, aligned with lower flange 12 of lower beam 8b, completing an essentially continuous bottom flange of longitudinal truss frame 6. Additionally, each support leg 42 includes bulkhead 42c, which is generally aligned with bulkheads 34c, resisting bending of the flanges of support leg 42 and concomitantly of the flanges of member 32. Bulkhead 42c may, as shown, be proximal to the connection of truss member 46b to the web of support leg 42, as seen in FIG. 2.

Each support leg 42 is depicted as, but not limited to, an open channel defined by a web and spaced apart flanges extending outwardly. Cross beams 44a and 44b are each depicted as an open channel defined by a web and spaced apart flanges extending downwardly.

Referring to FIG. 3, adjoining ends of adjacent sections 6 share a common lateral truss frame 40. Each member 32 and support leg 42 includes a plurality of aligned openings, many of which are used to receive carriage bolt (not shown) respective flanges of support leg 42 to corresponding flanges of adjacent sections 6. As shown in FIG. 3, when assembled together, bulkheads 34a and 42a, 34b and 42b, and 34c and 42c may be generally respectively aligned with each other, providing support to the adjacent vertical flanges. Off set bulkhead locations may provide similar support.

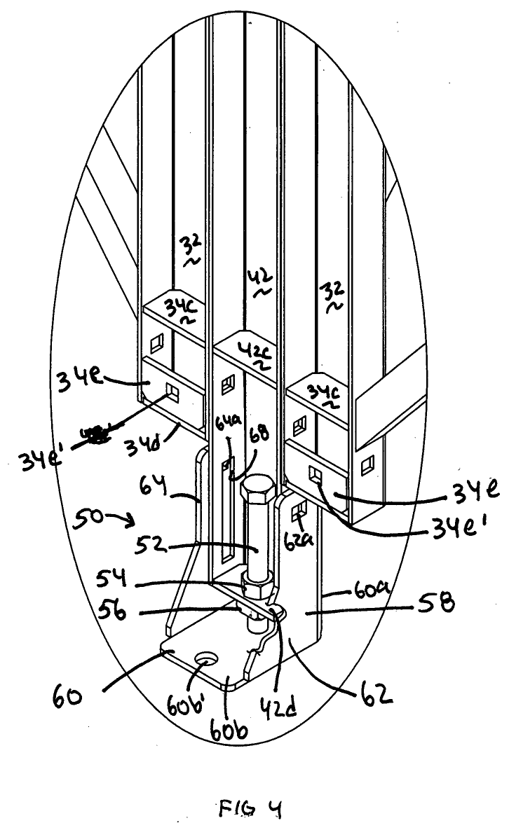

Referring to FIG. 4, support leg 42 may include adjustable foot 50. The lower end of support leg 42 includes bulkhead 42d, having a hold that supports and carries adjusting bolt 52, threadingly engaging threaded nut 54 and 56 disposed on opposite sides of bulkhead 42d. In the embodiment depicted, nut 56 is connected to bulkhead 42d so that nut 56 does not rotate.

Adjustable foot 50 includes base portion 58 which includes an L shaped bracket 60 having a vertical web portion 60a and a horizontal portion 60b, and two vertical side flanges 62 and 64, connected to bracket 60 and spaced apart a distance sufficient for the lower end of support leg 42 to fit in and slide with respect thereto. Each flange includes a bolt hole 62a and 64a which aligns with respective, corresponding elongated slot 66 (not seen) and 68.

Adjustable foot 50 allows adjustment of the height of each leg individually during installation. Adjusting bolt 52 is rotated so the conveyor can be raised or lowered to the correct, level height, and nut 54 can be tightened to secure it. A carriage bolt (not shown) or any suitable fastener may be disposed through openings 60c, 62a and 64a, and slots 42e, 66 and 68, and tightened, securely fixing support leg 42 at the desired height. Thereafter, jack bolt 52 may be removed if desired, or left in place. Base portion 60b may be connected to a supporting structure in any suitable fashion. Base portion 60b may include hole 60b′ through which a fastener may secure the base portion to the floor.

If the total weight of the conveyor, including the conveying medium and articles carried thereon, allows, the conveyor may be suspended from a ceiling, such as by attaching the top of support legs 42 to the appropriate structure of the ceiling, or may be supported by a mezzanine.

A goal in configuring the truss body comprising longitudinal truss frame 6 is to statically and dynamically optimize the system, such as for example optimizing mass, damping, stiffness and stability attributes to achieve a frame capable of supporting the conveying loads, with reduced vibration and noise. In the case of sortation conveyors, such optimization allows the conveyor to be operated at higher speeds.

As illustrated in the Figures, the span between the centers of support legs 42 is relatively short compared to conventional use of trusses, such as compared to the span that a longitudinal truss frame could span under static loading conditions. Relative to the lateral width of conveyor frame 2, the center distance between supports could be as great as four times the width, or could be any ratio less than four, such as ranging in ratio from about 4:1 to 1:1, in ratio increments of 0.1. In the embodiment depicted, the distance is five feet, although it could for example be ten feet. Although it could be longer, a span of about twelve feet or less is preferred.

Beams 8a, as well as beams 8b when present, are not continuous along the length of conveyor frame 2, having ends proximal the ends of frame sections 4. In the embodiment depicted, the ends of beams 8a and 8b are separated from the ends of corresponding beams in adjacent frame sections by members 32 and support legs 42. It may be possible to eliminate support legs 42, if one or both of the members 32 provide the support. It is also noted that although beams 8a and 8b are depicted as unitary beams, they could be composed of multiple pieces connected together, so long as the requisite rigidity was present.

Referring to FIGS. 1, 2 and 5, covers 48 may be included along the longitudinal sides of conveyor frame 2. Covers 48 may, as depicted, extend from proximal beam 8a to proximal adjustable foot 50, and may be configured for direct access to components, such as 48a (FIG. 5), carried by conveyor frame 2. As depicted, the longitudinal length of covers 48 match the longitudinal lengths of frame sections 4, although they may be of any suitable length. In areas where there are spur conveyors or any other structure that interfere with covers 48 covering substantially the entire side, shorter covers, such as depicted at 48b, may be used. Covers 48, 48b, may be attached to conveyor frame 2 in any suitable manner. The top edges of covers 48 may, for example, resiliently fit within the channel of beam 8a, with the bottom edges being attached to bulkhead 34e as described above. Covers 48 may be attached to bracket 48c carried by support leg 42 (see FIG. 2). Covers 48 provide safety by covering portions of the conveyor, are aesthetically pleasing, and serve to lessen noise. Sound dampening material, such as baffle 48d, may carried by conveyor frame 2 covered by covers 48, or carried by covers 48 (not shown for cover 48b).

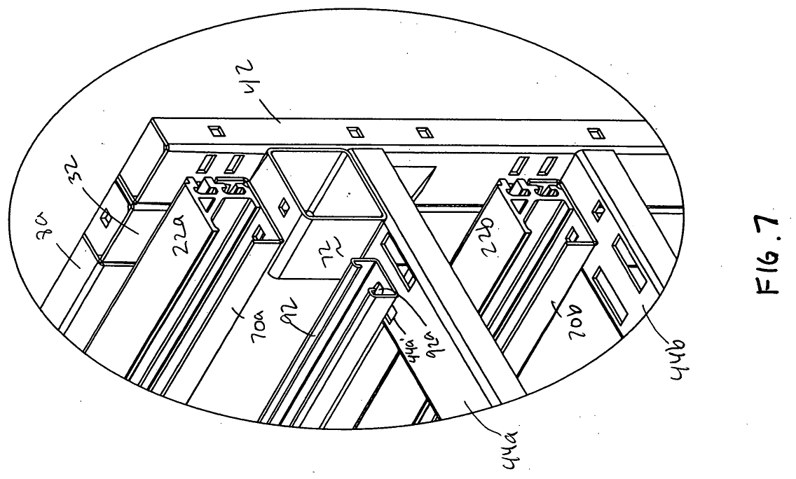

Referring to FIGS. 6 and 7, the lower portion of supports 22a and 22b, on each side of the conveyor, are disposed in and supported by respective upwardly opening channels 70a and 70b which may be respectively connected to upper and lower beams 8a and 8b through a threaded or other suitable fastener 26, extending through openings 28b in web 10. The upwardly facing channels 70a and 70b may also function as a trough to collect oil from the chain. The flanges of channels 70a and 70b resist bending and rotation of support 22a and 22b about a vertical axis, as well as help to maintain the perpendicular orientation between longitudinal truss frames 6 and lateral truss frames 40. Openings 28a and 28b are depicted in FIG. 2 as being vertically aligned: However, they may be longitudinally spaced from each other to spread out the load distributed to web 10, reducing local stress.

As seen in FIGS. 6 and 7, channels 70a may be supported at each end by a respective spacer 72, which, in the embodiment depicted, is a short rectangular tube connected to cross beam 44a and support leg 42. Spacer 72 may be of any configuration and attached to frame 2 in any suitable manner. Spacer 72 locates support 22a in the appropriate vertical position relative to cross beam 44a. Threaded fastener 74a, or any suitable fastener, secures channel 70a to spacer 72. Channels 70b are supported at both ends by cross beam 44b. The ends of channels 70b may be connected to cross beam 44b by threaded fasteners 74b. Spacer 72, as used in the depicted embodiment, allows channel 70a to be identical to channel 70b, as well as support 22a to be identical to support 22b, to standardize the parts. Channel 70a and or support 22a could be configured so as to eliminate the need for spacer 72.

Supports 22a and 22b could have a different configuration which provides the additional support and function of channels 70a and 70b, thereby eliminating channels 70a and 70b as separate components. Beams 8a and 8b could be combined with supports 22a and 22b, respectively, into respective one piece structures, possibly of unitary construction.

Although channels are depicted herein as a C-shaped cross section, channel as used herein includes a shape which resists bending, including configurations such as a hat section, an enclosed tube having a rectangular or curved cross sectional shape. It is noted that although the channels are depicted with continuous flanges, the flanges may be discontinuous. However, continuous or substantially continuous flanges are preferred.

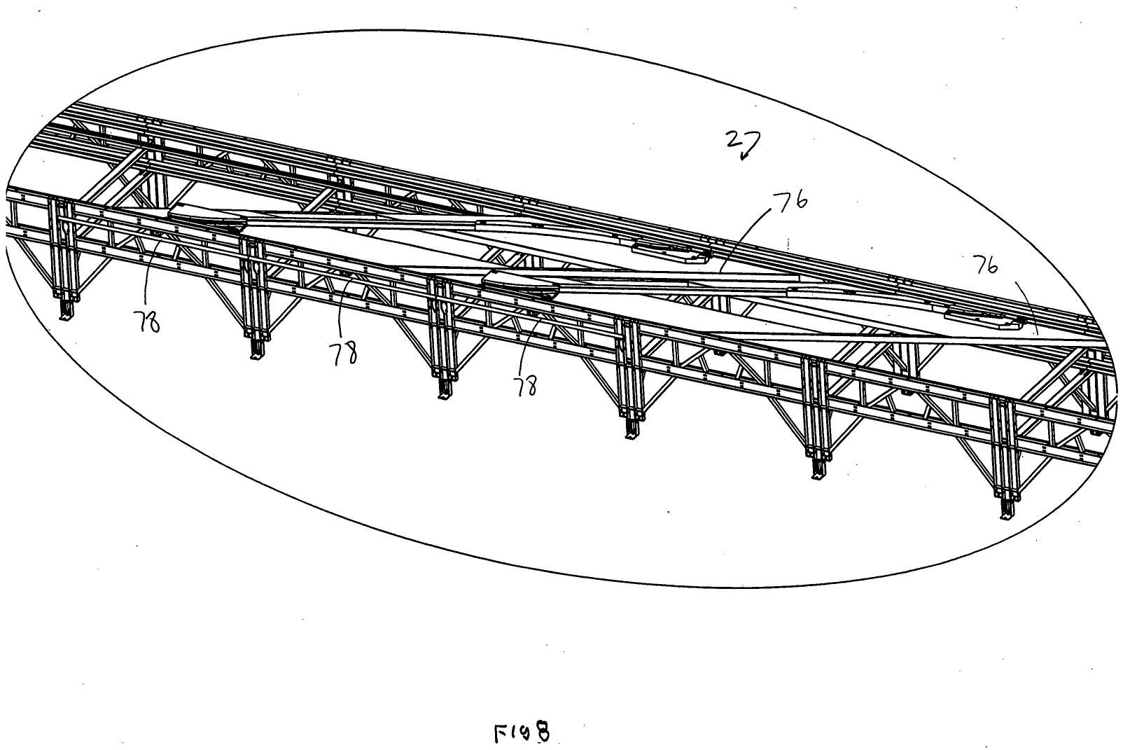

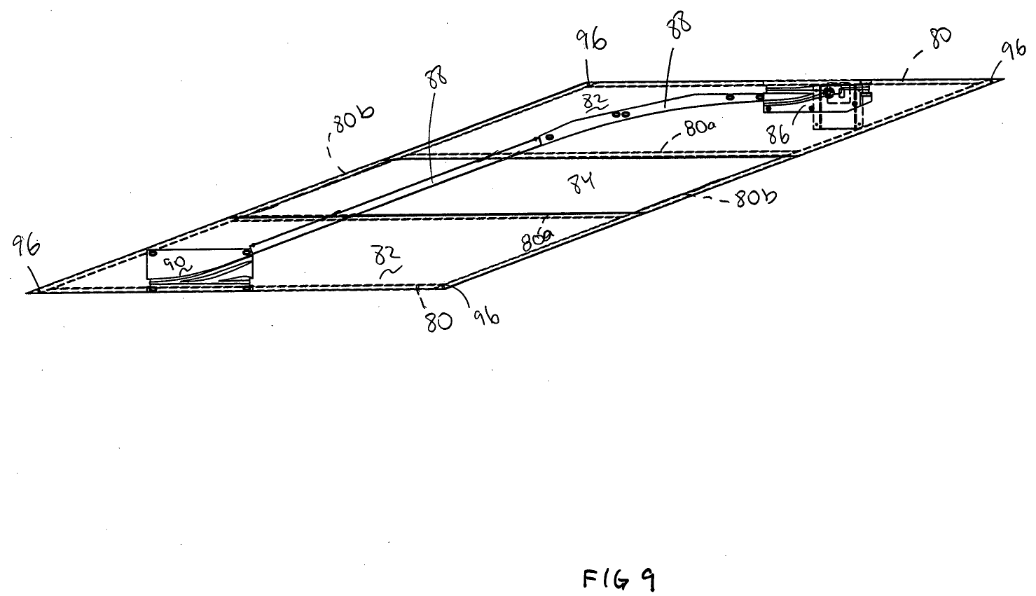

Referring to FIG. 8, a plurality of divert chassis 76 and spur conveyor supports 78 are illustrated mounted to conveyor frame 2. Referring also to FIG. 9, in the embodiment depicted, divert chassis 76 includes frame 80 having a parallelogram outer perimeter and interior frame members 80a extending longitudinally between side frame members 80b, with panels 82 mounted atop thereof, leaving open area 84. Divert chassis 76 carries divert switch 86, guide track 88 and return 90.

Referring also to FIGS. 6 & 7, in the embodiment depicted, frame sections 4 may include divert chassis mounting track 92 (omitted from FIG. 2 for clarity) having a length corresponding to a multiple of the length of frame sections 4 so that the ends may be connected to cross beams 44a of lateral truss frames 40 by a bolt or other suitable fastener (not shown) disposed through opening 92a and slot 44a′. Slot 44a′ allows proper lateral alignment and adjustment of chassis mounting track 92. In the embodiment depicted, divert chassis mounting track 92 has a length twice the length of frame section 4, ten feet total. In the embodiment depicted, chassis mounting track 92 has a upwardly opening C shaped cross section with ends 92b each having a C shaped cross section opening downwardly, providing additional strength and rigidity to chassis mounting track 92. In the embodiment depicted, divert chassis 76 is connected to chassis mounting track 92 by threaded fasteners 94 disposed through holes 96 located at the corners of divert chassis 76. As depicted, fasteners 94 threadingly engage nuts 98 disposed in the interior of chassis mounting track 92. Nuts 98 are configured to engage ends 92b when fasteners 94 are tightened. In the embodiment shown, nuts 98 are strut nuts designed to engage the cross section of chassis mounting track 92.

Chassis mounting tracks 92 allow divert chassis 76 to be located at any desired longitudinal location along conveyor frame 2. Chassis mounting tracks 92 essentially function as adaptors between conveyor frame 2 and divert chassis 76, mounting to individual frame sections 4 at discrete locations (to the cross beams 44a of lateral truss frames 40) while allowing divert chassis 76 to be mounted at any position along the chassis mounting track 92. Thus, by including chassis mounting tracks 92 at the appropriate frame section 4, the remaining configuration and construction of conveyor frame 2 is not required to vary in dependence upon the location of divert chassis 76. Adjustments in the locations of diverts may easily be made during installation.

Although chassis mounting tracks 92 are only required at the locations where a divert chassis 76 is to be disposed, every frame section 4 could include a chassis mounting track 92. Alternatively, the length of chassis mounting tracks 92 may be of any suitable standardized lengths, or custom made for each installation. Chassis mounting tracks 92 may be of any configuration suitable for supporting divert chassis 76.

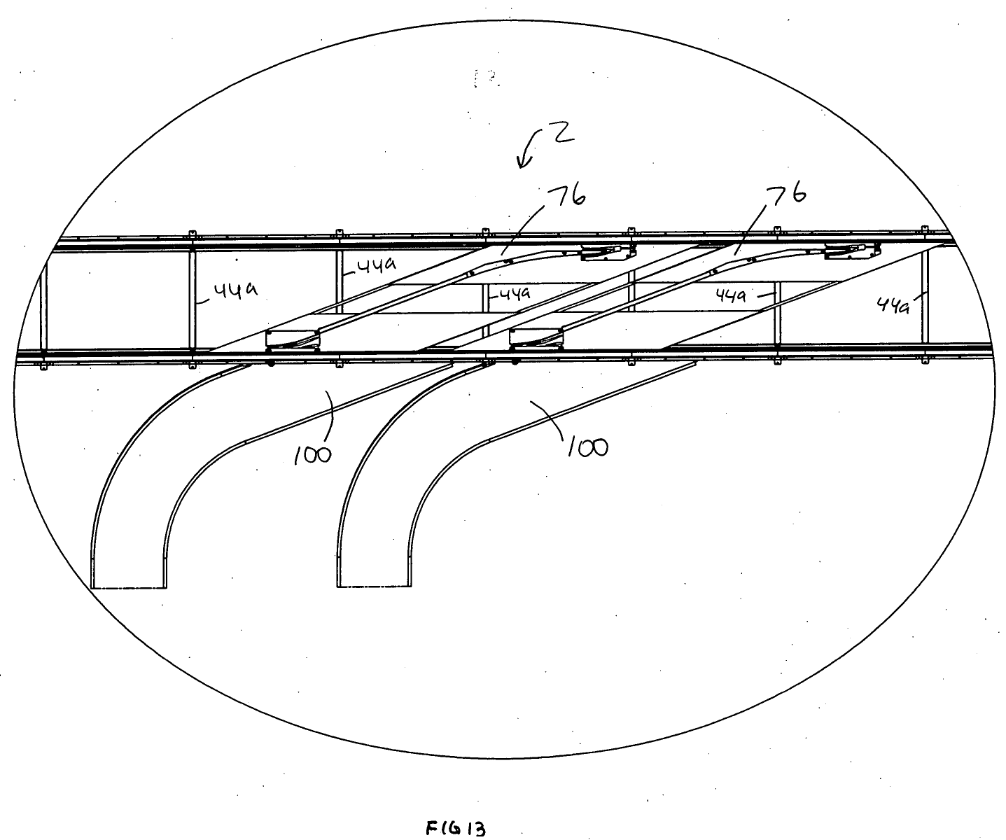

Divert chassis 76 may be of any configuration suitable for supporting switch 86, guide track 88 and return 90, and mounting to conveyor frame 2. Divert chassis 76 are not required to have a continuous frame 80 or panels as depicted and may be multiple pieces. The depicted parallelogram shape of divert chassis 76 allow adjacent divert chassis 76 to be disposed close to each other, overlapping longitudinally and laterally as seen in FIG. 13.

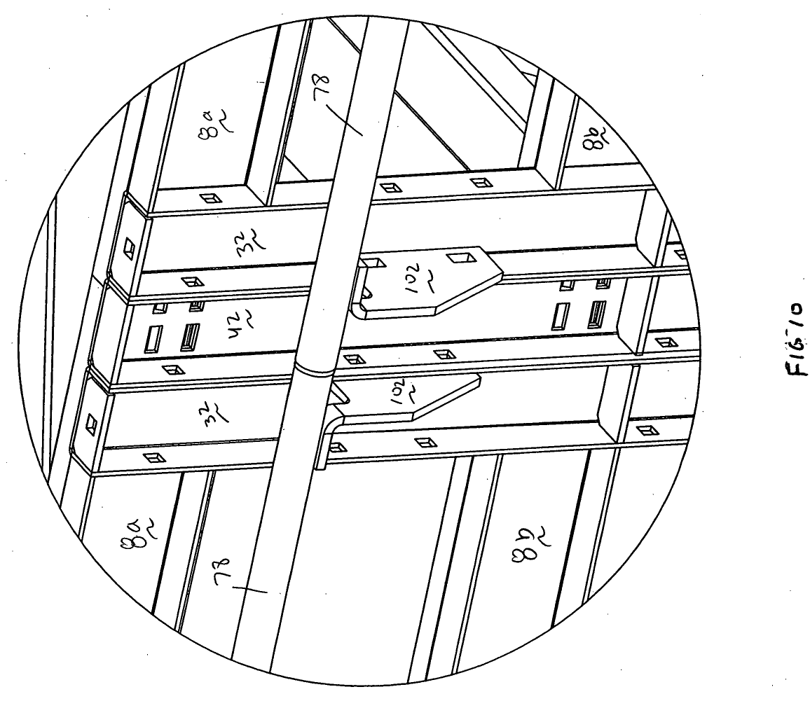

Referring to FIGS. 5 & 6, spur conveyor supports 78 are illustrated supporting edge 100a of spur conveyor 100. Referring also to FIG. 10, in the embodiment depicted, each support 78 has a length corresponding to the length of a frame section 4 and is supported at each end at by respective brackets 102, which in the embodiment depicted is connected to support 78. In the embodiment depicted, each bracket 102 is connected to the flange of member 32 of the particular frame section 4 and the adjoining flange of support leg 42 by a bolt.

As best seen in FIG. 6, clamp 104 is shaped complementarily to engage support 78, and is depicted as generally having a C shape. Clamp 104 supports edge 100a through threaded shaft 106 and adjustment nuts 108. Supports 78 essentially function as adaptors between conveyor frame 2 and spur conveyors 100, mounting to individual frame sections 4 at discrete locations (to members 32 of truss frames 6 and support legs 42 lateral truss frames 40) while allowing spur conveyors 100 to be mounted at any longitudinal position along the support 78. Thus, by including supports 78 at the appropriate frame sections 4, the remaining configuration and construction of conveyor frame 2 is not required to vary in dependence upon the location of spur conveyors 100. Adjustments in the locations of spur conveyors 100 may easily be made during installation. Alternatively, multiple mounting points, configured complementary with any particular configuration of a spur conveyor support bracket, could be provided along the length of longitudinal truss section 6, such as mounting to holes 28a or 28b of either or both beams 8a and 8b.

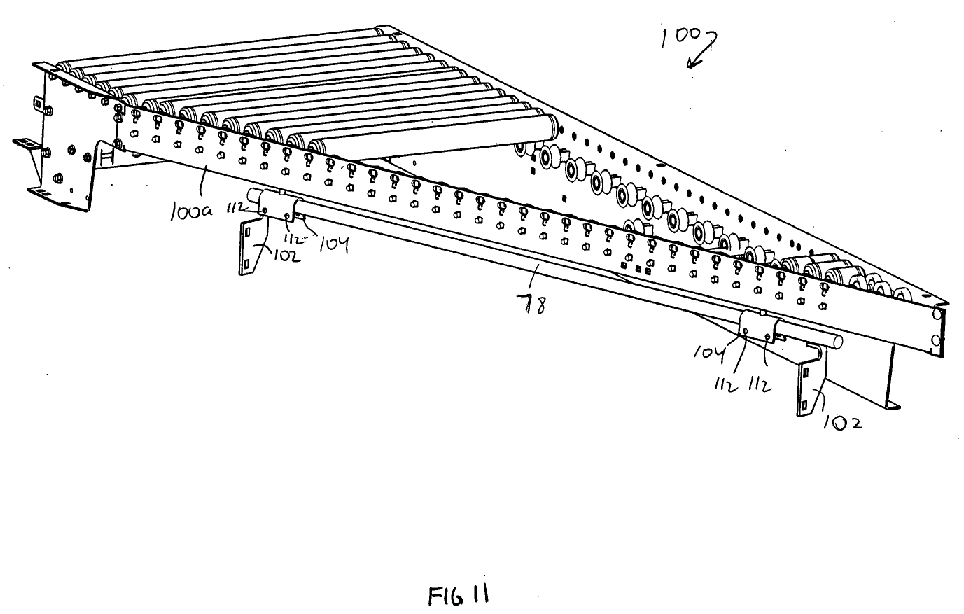

Although supports 78 are only required at the locations where a spur conveyor 100 is to be disposed, every frame section 4 could include a support 78. In the embodiment depicted, as can be seen in FIG. 11, although the length of edge 100a is longer than a single support 78, and concomitantly longer than a single frame section 4, clamps 104 may be spaced apart a distance less than the length of a single support 78. The location of spur conveyor 100 relative to individual frame sections 4 may result in the distance between clamps 104 spanning two frame sections, requiring two supports 78. A single clamp 104 may also be located that it spans two supports 78. It is noted that the configuration of support 78 and bracket 102 allows clamps 104 to be disposed above brackets 102 without interference. Alternatively, the length of support 78 may be any suitable length, such as two frame sections 4, or custom made for each installation. Support 78 may be of any configuration suitable for supporting spur conveyor 100.

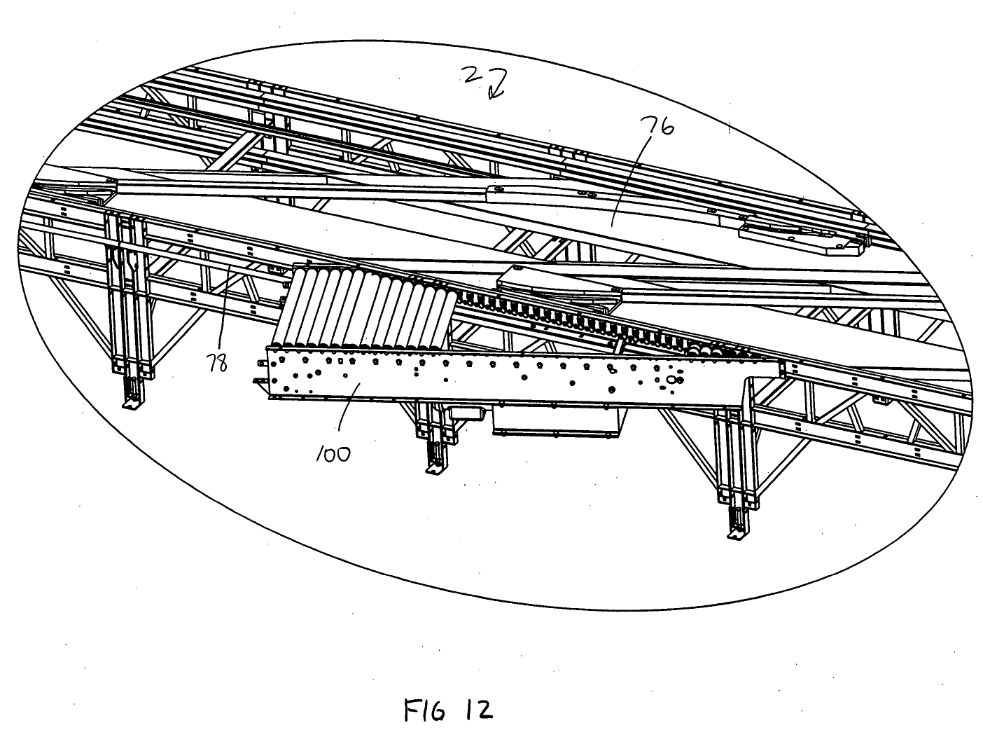

Referring to FIG. 12, during installation, spur conveyor 100 (supporting legs not shown in FIG. 12) is located at the appropriate location along conveyor frame 2, placing clamps 104 in engagement with supports 78. The configuration of supports 78 and clamps 104 allows spur conveyor 100 to be slid along support 78 for achieving the exact desired location, and it is noted that rollers, bearings or low friction surfaces may be included to make such movement of spur conveyors 100 relative to supports 78 easier. When in the desired location, clamps 104 may be drawn tightly against supports 78 to prevent longitudinal movement by tightening threaded fasteners 110 (see FIG. 6) which are disposed through holes 112. In the event that a particular bracket 102 obstructs one of the two holes 112, that threaded fastener 110 may be omitted. Before or after securing clamps 104 to supports 78, the height of spur conveyor 100 may adjusted to the appropriate level through adjustment nuts 108.

Alternatively, spur conveyor 100 could carry a structure similar to support 78 with structures similar to clamps 102 carried at the appropriate locations by frame sections 4.

The modular construction of conveyor frame 2 allows individual sections, such as longitudinal truss frames 6 and lateral truss frames 40 to be manufactured separately and shipped unassembled to the installation site. The size and truss construction of longitudinal truss frames 6 and lateral truss frames 40 can be easily handled without cranes and lifts, allowing them to be assembled into a series of frame sections 4. The other components of conveyor frame 2 may then be easily added, such as supports 22a and 22b, guides 20a and 20b, divert chassis mounting tracks 92 and supports 78. Divert chassis 76 and spur conveyors can then be located appropriately, and the moving conveyor elements 16 and drive element 18 installed.

The modular construction of conveyor frame 2 also allows individual sections to be assembled together in lengths, for example 50 feet, and shipped as a preassembled unit. As a result of the reduced weight of such a conveyor constructed according to teachings of the present invention relative to the weight of similar length sections having a solid beam for each side rail, the assembled 50 foot long preassembled unit including supports 22a and 22b, guides 20a and 20b, divert chassis 76, divert chassis mounting track 92 and supports 98 is light enough to be moved with a fork lift. Caster wheels may be placed on the feet to allow movement without a forklift.

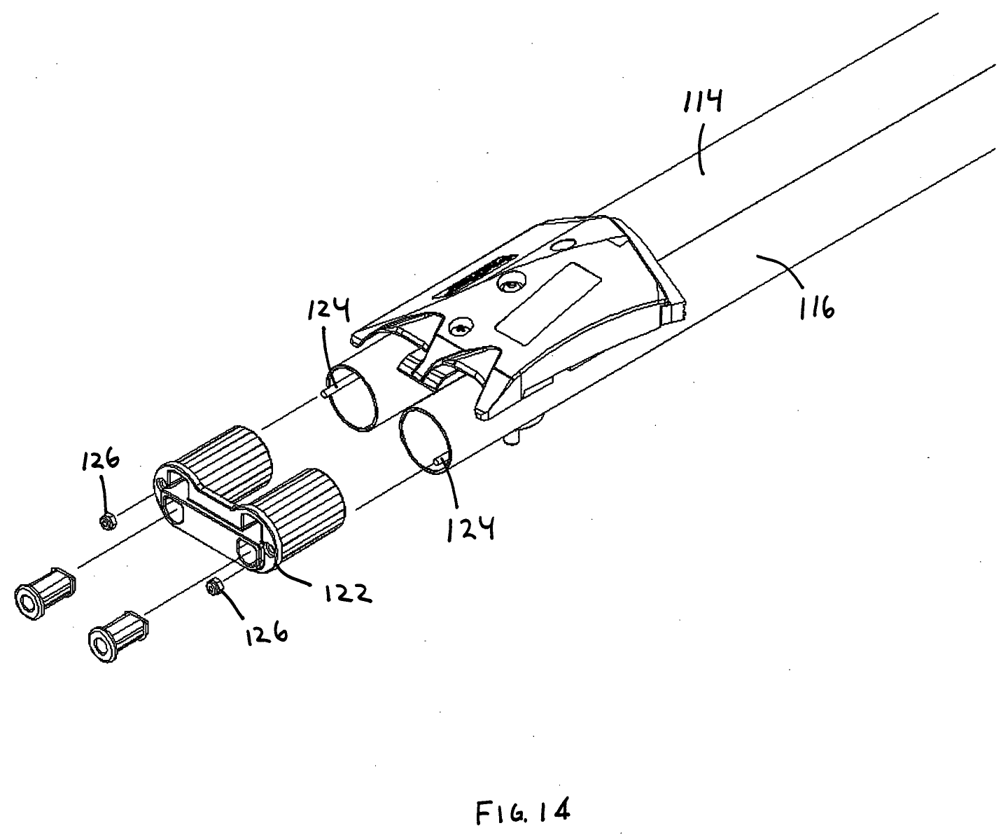

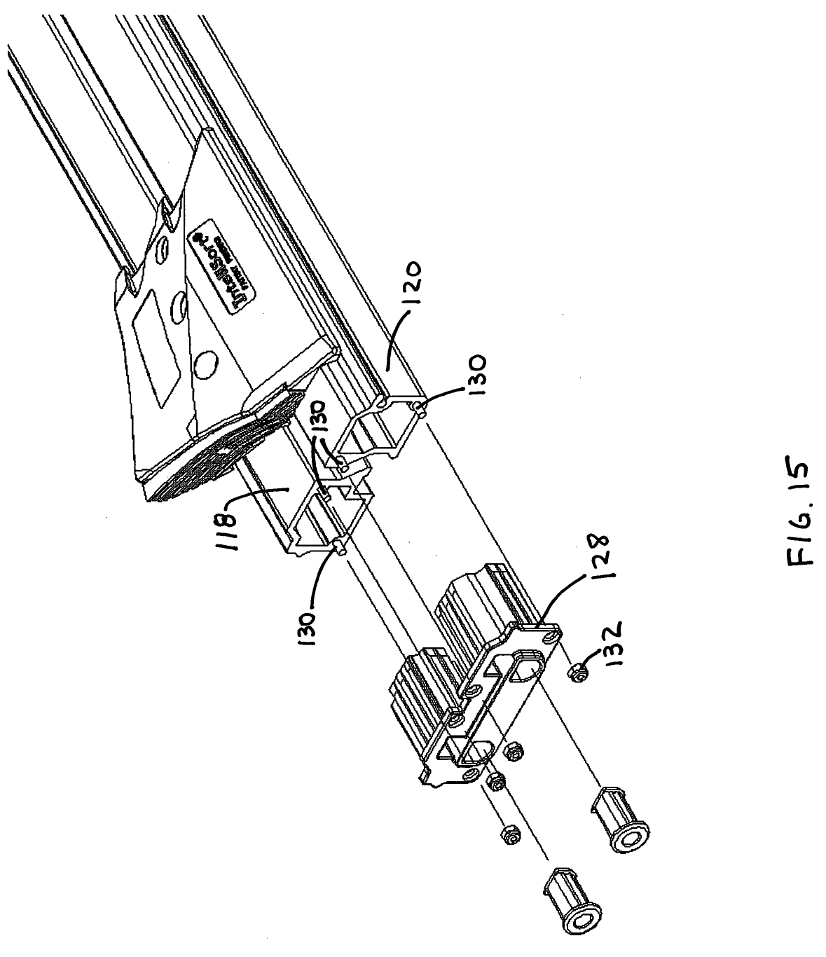

FIG. 14 shows a pair of tubes 114 and 116 and FIG. 15 shows a pair of slats 118 and 120. The pair of tubes 114 and 116 and pair of slats 118 and 120 form respective flights which may be the moving conveying medium of a sortation conveyor, a combiner or any suitable conveyor.

Tubes 114 and 116 and slats 118 and 120 are formed of any suitable composite construction. Any suitable reinforcement material (loose fibers, woven fibers particles, flakes or fillers), such as carbon fiber, fiberglass, polyester, nylon, cotton, Aramid fibers, Kevlar, or metal or composite cabling, etc., may be used with a suitable bonding agent as the matrix to suitable properties. Any suitable bonding agents that bond like or unlike materials to engineering standards of thickness and rigidity may be used as the matrix, such as epoxies, polyesters, acrylics, polymethacrilimides, etc. can be included.

Tubes 114 and 116 and slats 118 and 120 may be formed by any suitable method, such as extruding, pultruding, blow molding, injection molding, or laying up. Internal truss members, or honeycomb structure, for example extending the length, may be formed inside of tubes 114 and 116 and slats 118 and 120. Such truss members could be in the form of any suitable configuration, such a V shape. The internal cavity may be filled with any suitable material for strengthening or dampening, such as foam or the like.

Tubes 114 and 116 and slats 118 and 120 may have properties that vary in particular directions. They may be configured to be stronger in one direction, for example, wall thicknesses may be greater at the sides providing greater strength to resist vertical deflection. Directional properties may be selected so that the tubes or slats yield to protect people or conveyor components in the event of problems.

Referring to FIG. 14, tubes 114 and 116 are held in the required spaced apart relationship by end cap 122. Tubes 114 and 116 include one or more respective connecting members 124 for connecting end cap 122 thereto. In the embodiment depicted, connecting members 124 are illustrated as rods having at least an end that is threaded, which extend through corresponding holes formed in end cap 122. Nuts 126, preferably locking nuts such as a Nylock nut, engage the threaded ends to hold end cap 122 to tubes 114 and 116.

Similarly, as illustrated in FIG. 15, slats 118 and 120 are held together by end cap 128. Each slat 118 and 120 is depicted as including a plurality of connecting members 130 (shown as two connecting member 130 for each, although one per slat may be used if suitable) which in the embodiment depicted are illustrated as having at least an end that is threaded, which extend through corresponding holes formed in end cap 130. Nuts 132, which may be Nylock nuts, engage the threaded ends to hold end cap 130 to slats 118 and 120.

Connecting members 124 and 130 may be embedded in the walls of the tubes or slats, such as illustrated with slats 118 and 120, or may be disposed in the interior cavity, such as illustrated with tubes 114 and 116. If not embedded in the walls, the connecting members must be held in place. The connecting members may extend the entire length of the tubes and slats, with a single connecting member engaging the end caps on both ends, or may be shorter if connected to the tubes and slats in a manner sufficient to hold the end caps on.

Referring to FIG. 1, lower cover 48, as well as the upper cover (not shown) may be made of a composite material, which may be tinted. The covers may have sound dampening material disposed on their inside face.

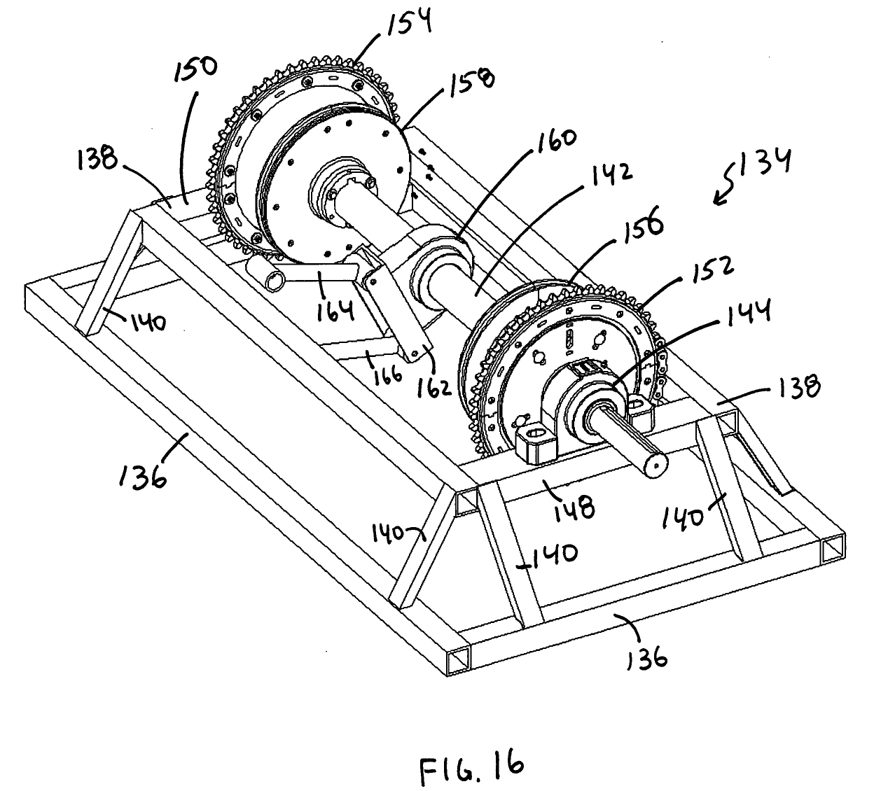

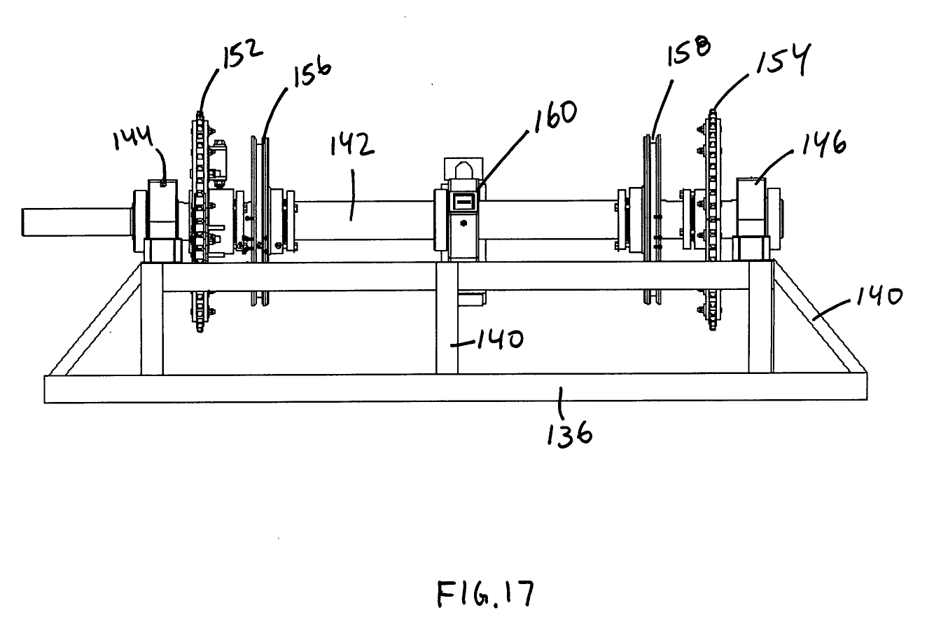

Referring to FIGS. 16 and 17, powertrain chassis 134 includes lower frame 136 and upper frame 138 interconnected by a plurality of inclined upright members 140. Powertrain chassis 134 supports shaft 142 through bearings 144 and 146 carried by end members 148 and 150. Shaft 142 carries chain sprockets 152 and 154 and pusher pin cams 156 and 158. Shaft 142 may be driven by a motor (not shown).

Powertrain chassis 134 is configured to be installed as a unit into a supporting frame (not shown) located at the end of conveyor frame 2, which is configured to receive and support powertrain chassis 134 in the appropriate position to drive the chains or other driven elements of a sortation conveyor. Shaft 142 is supported between bearings 144 and 146 by bearing 160 to raise critical velocity. In the embodiment depicted, bearing 160 is supported by member 162, which is supported by members 164 and 166. Members 164 and 166 may be connected to any suitable supporting structure, such as to powertrain chassis 134 or to the supporting frame.

The foregoing description of a preferred embodiment of the invention has been presented for purposes of illustration and description. It is not intended to be exhaustive or to limit the invention to the precise form disclosed. Although specifically disclosed in conjunction with a sortation conveyor, the teachings of the present invention are not limited to use with a sortation conveyor. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims submitted herewith.

1. A conveyor comprising:
a. a conveying medium configured to convey articles in a longitudinal direction;
b. a conveyor frame having first and second sides extending in the longitudinal direction, and a width extending laterally between said first and second sides, said conveyor frame comprising at least one frame section having first and second sides corresponding to said first and second sides of said conveyor frame, each of said at least one frame section having a respective length parallel to said longitudinal direction, said length being short, each of said at least one frame section having longitudinally spaced apart section ends, each section end being supported on said first and second sides externally relative to said conveyor; and
c. each of said at least one frame section comprising at least two laterally spaced apart trussed beams extending in said longitudinal direction, each of said trussed beams respectively disposed proximal said first and second sides of said conveyor frame, said conveying medium being supported by said trussed beams.

2. The conveyor of claim 1, wherein said conveying medium comprises a fixed conveyor.

3. The conveyor of claim 2, wherein said fixed conveyor comprises a plurality of rollers, each of said rollers having respective ends which are supported by respective trussed beams.

4. The conveyor of claim 1, wherein each of said trussed beams have respective ends, each of said respective ends being connected to a generally vertical member.

5. The conveyor of claim 4, wherein each said generally vertical member is connected to a support leg, each said respective support leg being supported externally.

6. The conveyor of claim 4, wherein each respective trussed beam is supported by a respective plurality of truss members, at least a respective one of said plurality of truss members being connected to said respective trussed beam.

7. The conveyor of claim 6, wherein at least a respective one of said truss members is connected to one of said respective vertical members.

8. The conveyor of claim 1, wherein said conveying medium comprises a moving conveying medium.

9. The conveyor of claim 8, wherein said moving conveying medium comprises a conveying run and a return run underlying said conveying run, said conveying run being supported by at least one upper pair of said spaced apart trussed beams, and said return run being supported by at least one lower pair of said spaced apart trussed beams.

10. The conveyor of claim 9, wherein said at least one frame section comprises a first plurality of truss members disposed on said first side and a second plurality of truss members disposed on said second side, one or more of said truss members of said first plurality of truss members extending between said trussed beams disposed on said first side, one or more of said truss members of said second plurality of truss members extending between said trussed beams disposed on said second side.

11. The conveyor of claim 1, wherein a plurality of said at least two trussed beams comprises respective flat beams.

12. The conveyor of claim 1, wherein a plurality of said at least two trussed beams comprises respective channels.

13. The conveyor of claim 12, wherein said channels are enclosed.

14. The conveyor of claim 12, wherein said channels have a C shaped cross section.

15. The conveyor of claim 14, wherein said channels open outwardly.

16. The conveyor of any of claims 1-4 and 6-15, wherein each of said section ends are connected to a respective support leg on said first side and to a respective support leg on said second side, each said respective support leg being supported externally.

17. The conveyor of claim 16, comprising at least one laterally extending trussed beam having first and second ends, said first end being connected to the support leg disposed on said first side of the respective section end, said second end being connected to the support leg disposed on said second side of the respective section end.

18. The conveyor of claim 16, wherein the ratio of the length to the width is less than about 4 to 1.

19. The conveyor of claim 16, wherein the length is no greater than about 12 feet.

20. The conveyor of any of claims 1-15, wherein the ratio of the length to the width is less than about 4 to 1.

21. The conveyor of any of claims 1-15, wherein the length is no greater than about 12 feet.

22. The conveyor of claim 1, wherein said conveyor is a sortation conveyor.

23. A sortation conveyor comprising:
a. a moving conveying medium comprises a conveying run configured to convey articles in a longitudinal direction;
b. a conveyor frame having first and second sides extending in the longitudinal direction, and a width extending laterally between said first and second sides, and comprising at least two laterally spaced apart first trussed beams extending in said longitudinal direction respectively disposed proximal said first and second sides of said conveyor frame, said conveying run being supported by said first trussed beams.

24. The sortation conveyor of claim 23, comprising a plurality of first longitudinal truss frames comprising said first side and a plurality of second longitudinal truss frames comprising said second side, each of said first longitudinal truss frames including at least one of said first trussed beams, each of said second longitudinal frames including at least one of said first trussed beams.

25. The sortation conveyor of claim 24, wherein each longitudinal truss frame includes a respective plurality of truss members, at least one of said plurality of truss members being connected to said at least one first trussed beam included with that longitudinal truss frame.

26. The sortation conveyor of claim 25, wherein said first trussed beams have respective ends, and each of a plurality of said longitudinal truss frames comprises at least one respective member connected to one of said respective ends of that first trussed beam included with that longitudinal truss frame.

27. The sortation conveyor of claim 26, wherein a plurality of said respective members are connected to respective support legs.

28. The sortation conveyor of claim 23, wherein said conveying medium comprises a return run underlying said conveying run, at least two laterally spaced apart second trussed beams extending in said longitudinal direction respectively disposed proximal said first and second sides of said conveyor frame, said return run being supported by said second trussed beams.

29. The sortation conveyor of claim 28, comprising a plurality of first longitudinal truss frames comprising said first side and a plurality of second longitudinal truss frames comprising said second side, each of said first longitudinal truss frames including at least one of said first trussed beams and at least one of said second trussed beams, each of said second longitudinal frames including at least one of said first trussed beams and at least one of said second trussed beams.

30. The sortation conveyor of claim 29, wherein each longitudinal truss frame includes a respective plurality of truss members, at least one of said plurality of truss members being connected to said at least one first trussed beam included with that longitudinal truss frame and at least one of said plurality of truss members being connected to said at least one second trussed beam included with that longitudinal truss frame.

31. The sortation conveyor of claim 30, wherein said first and second trussed beams have respective ends, and each of a plurality of said longitudinal truss frames comprises at least one respective member connected to one of said respective ends of those first and second trussed beams included with that longitudinal truss frame.

32. The sortation conveyor of claim 31, wherein a plurality of said respective members are connected to respective support legs.

33. The sortation conveyor of claim 31, wherein at least one of said plurality of truss members is connected to one of said at least one respective member.

34. The sortation conveyor of claim 29, wherein said first and second trussed beams have respective first and second ends, and wherein each of a plurality of said longitudinal truss frames comprises:
a. a first generally vertical member connected to said first ends of said first and second trussed beams included with that longitudinal truss frame;
b. a second generally vertical member connected to said second ends of said first and second trussed beams included with that longitudinal truss frame; and
c. a respective plurality of truss members, at least one of said plurality of truss members being connected to said first trussed beam and to said second trussed beam included with that longitudinal truss frame; and at least one of said plurality of truss members being connected to said at least one of said first and second vertical members and to at least one of said first and second trussed beams included with that longitudinal truss frame.

35. The sortation conveyor of claim 34, wherein said first and second truss members are supported externally.

36. The sortation conveyor of claim 23 or 28, wherein a plurality of said first and second trussed beams comprises respective flat beams.

37. The sortation conveyor of claim 23 or 28, wherein a plurality of said at least two trussed beams comprises respective channels.

38. The sortation conveyor of claim 37, wherein said channels are enclosed.

39. The sortation conveyor of claim 38, wherein said channels have a C shaped cross section.

40. The sortation conveyor of claim 39, wherein said channels open outwardly.

41. A sortation conveyor comprising:
a. a moving conveying medium comprises a conveying run configured to convey articles in a longitudinal direction and a return run underlying said conveying run;
b. a conveyor frame having first and second sides extending in the longitudinal direction, and a width extending laterally between said first and second sides, and comprising a plurality of first longitudinal truss frames comprising said first side and a plurality of second longitudinal truss frames comprising said second side;
c. each of said first and second longitudinal truss frames comprising at least one first trussed beam which supports said conveying run, and at least one second trussed beam which supports said return run; and
d. each of said first and second longitudinal truss frames comprising respective first and second ends, each of said respective first and second ends being supported externally relative to said conveyor.

42. The sortation conveyor of claim 41, comprising a respective lateral truss frame supporting the first respective ends of a first pair of first and second longitudinal truss frames and the second respective ends of a second pair of first and second longitudinal truss frames; and said transverse truss frames comprising a first support leg connected to said first longitudinal truss frames of said first and second pair of longitudinal truss frames and a second support leg connected to said second longitudinal truss frames of said first and second pair of longitudinal truss, and at least one trussed beam respectively connected at its ends to said first support leg and said second support leg.

43. A conveyor comprising:
a. a conveying medium configured to convey articles in a longitudinal direction;
b. a conveyor frame having first and second sides extending in the longitudinal direction, and a width extending laterally between said first and second sides; and
c. a lateral truss frame extending between said sides of said conveyor frame, said transverse truss frames comprising first and second spaced apart vertical members and at least one trussed beam respectively connected at its ends to said first support leg and said second support leg.

44. The conveyor of claim 43, comprising a plurality of truss members, at least one of said plurality of truss members being connected to said at least one trussed beam and to said first support leg.

45. A conveyor comprising:
a. a conveying medium configured to convey articles in a longitudinal direction;
b. a conveyor frame having an entrance and an exit, and first and second sides extending in the longitudinal direction, and a width extending laterally between said first and second sides, said conveyor frame comprising a plurality of substantially identical frame sections;
c. each frame section having first and second sides corresponding to said first and second sides of said conveyor frame, and comprising first and second substantially identical longitudinal truss frames laterally spaced from each other; and
d. each longitudinal truss frame comprising at least one trussed beam which supports said conveying run on opposite sides thereof, a first and second generally vertical members, each end of said trussed beam being connected to a respective vertical member, and a plurality of truss elements, at least one of said plurality of truss elements being connected to said trussed beam and one of said vertical members.

46. A conveyor comprising:
a. a conveying medium configured to convey articles in a longitudinal direction;
b. a conveyor frame having first and second sides extending in the longitudinal direction, and a width extending laterally between said first and second sides, said conveyor frame comprising at least one frame section having first and second sides corresponding to said first and second sides of said conveyor frame, each of said at least one frame section having a respective length parallel to said longitudinal direction, said length being selected to statically and dynamically optimize the conveyor frame, each of said at least one frame section having longitudinally spaced apart section ends, each section end being supported on said first and second sides externally relative to said conveyor; and
c. each of said at least one frame section comprising at least two laterally spaced apart trussed beams extending in said longitudinal direction, each of said trussed beams respectively disposed proximal said first and second sides of said conveyor frame, said conveying medium being supported by said trussed beams.

47. The conveyor of claim 46, wherein said length being selected to optimize mass, damping, stiffness and stability attributes such that said conveyor frame is capable of supporting conveying loads while vibration and noise is optimized.
